(19) United States
(12) Patent Application Publication
(10) Pub. No.: US 2021/0221456 A1
(43) Pub. Date: Jul. 22, 2021

(54) VERSATILE UTILITY TRAILER

(71) Applicant: Rick Kaiser, Atwater, MN (US)

(72) Inventor: Rick Kaiser, Atwater, MN (US)

(21) Appl. No.: 17/153,162

(22) Filed: Jan. 20, 2021

Related U.S. Application Data
(60) Provisional application No. 62/964,349, filed on Jan. 22, 2020.

(51) Int. Cl. B62D 63/06; B62D 25/20; B62D 63/08

(52) U.S. Cl. CPC B62D 63/062; B62D 63/08; B62D 25/20; B62D 25/209

(57) ABSTRACT

A versatile trailer may include a frame including a first support tube in a longitudinal direction and second support tube in a lateral direction, wherein the first support tube is longer than the second support tube and is perpendicular to the second support tube. The trailer may further include a middle support plate at an intersection of the first and second support tubes where the middle support plate is attached to the first and second support tubes, a plurality of inner support channels laterally extending from the first support tube where each of the plurality of inner support channels is perpendicular to the first support tube, and an aluminum sheet connected to the frame. The trailer may include removable wheels and sides.

### CLAIM OF PRIORITY

This patent application claims the benefit of U.S. Provisional Patent Application No. 62/964,349, filed Jan. 22, 2020, which is incorporated by reference herein in its entirety.

### TECHNICAL FIELD

The present disclosure relates generally to trailers, and more particularly, to versatile trailers, such as utility trailers, capable of being used in a variety of implementations.

### BACKGROUND

Various trailers have been designed for use for various purposes. For example, on-road trailers are designed for use at high-way speed, lawn trailers are designed to be pulled behind lawn tractors, and game carts are designed to be pulled behind all-terrain vehicles over rough terrain.

What is needed is an improved utility trailer with increased versatility for various uses.

### BRIEF DESCRIPTION OF THE DRAWINGS

Various embodiments are illustrated by way of example in the figures of the accompanying drawings. Such embodiments are demonstrative and not intended to be exhaustive or exclusive embodiments of the present subject matter.

FIGS. 1-2 illustrate, by way of example and not limitation, images of the trailer attached to different vehicles where the trailer is in a first orientation with the aluminum sheet below the frame.

FIGS. 3-4 illustrate, by way of example and not limitation, images of an all-terrain vehicle loaded on the trailer.

FIGS. 5-6 illustrate, by way of example and not limitation, additional images of elements of the trailer.

FIGS. 7-10 illustrate, by way of example and not limitation, images of the trailer with the aluminum sheet above the frame, and illustrates the trailer with and without the removable sides.

FIG. 11 illustrates, by way of example and not limitation, the receiver hitch tube inserted to the frame of the trailer and an inner hitch tube attached to the receiver hitch tube.

FIGS. 12-13 illustrate, by way of example and not limitation, the trailer with the sides removed.

FIGS. 14-16 illustrate, by way of example and not limitation, images of the removable wheel being inserted into a main support tube and secured within the main support tube with a pin.

FIGS. 17-18 illustrate, by way of example and not limitation, different assembled elements of the trailer.

FIGS. 19-20 illustrate, by way of example and not limitation, the trailer configured as a ramp such as may be used to load game into a truck bed.

FIGS. 21-27 illustrate, by way of example and not limitation, different images of the trailer configured as a ramp up to a truck bed.

FIGS. 28-31 illustrate, by way of example and not limitation, images of the trailer being loaded into a truck bed.

FIGS. 32-34 illustrate the frame and aluminum sheet connected to the vehicle hitch without wheels to function as a hitch-mounted, vehicle cargo tray.

FIGS. 35-40 illustrate, by way of example and not limitation, images of the trailer attached to different vehicles where the trailer is in a wide orientation with the removable wheels attached to the shorter ends of the frame.

FIG. 41 illustrates that the weight of the trailer is about 160 pounds.

FIGS. 42-45 illustrate the trailer holding a load of wood where total weight of the trailer and wood is about 1,780 pounds.

FIGS. 46-48 illustrate the frame and aluminum sheet used in a table.

FIGS. 49-50 illustrates a trailer with a ski adapter.

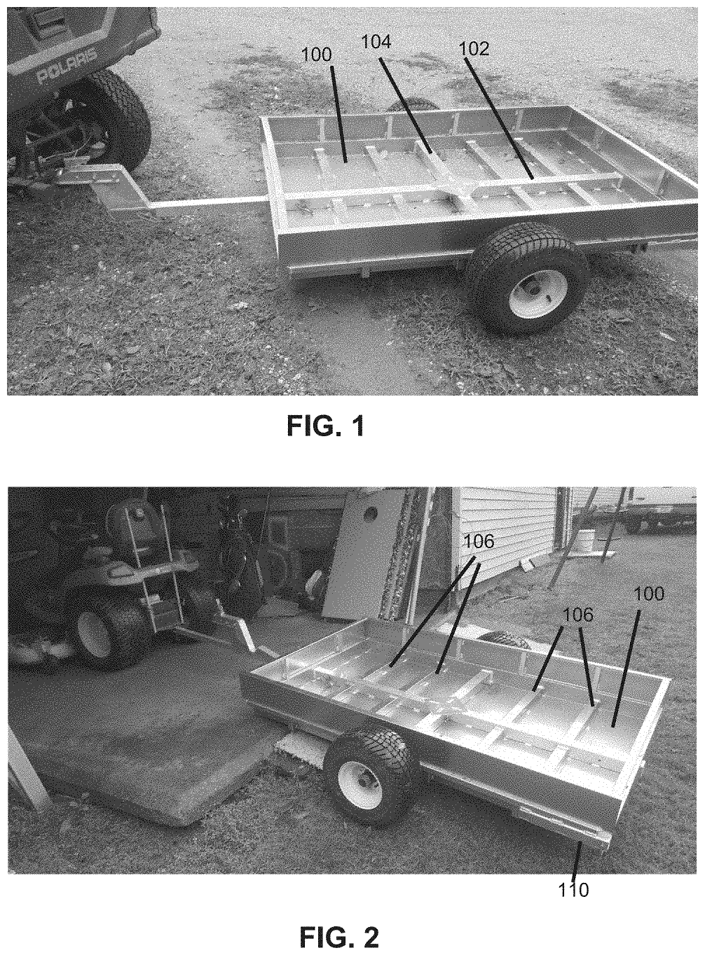

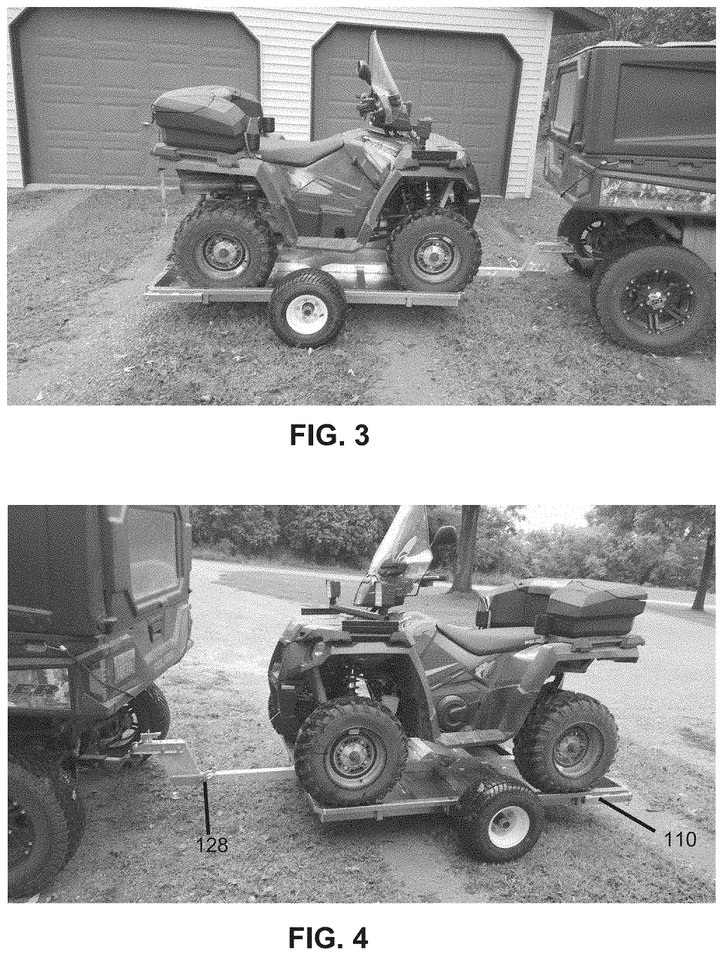

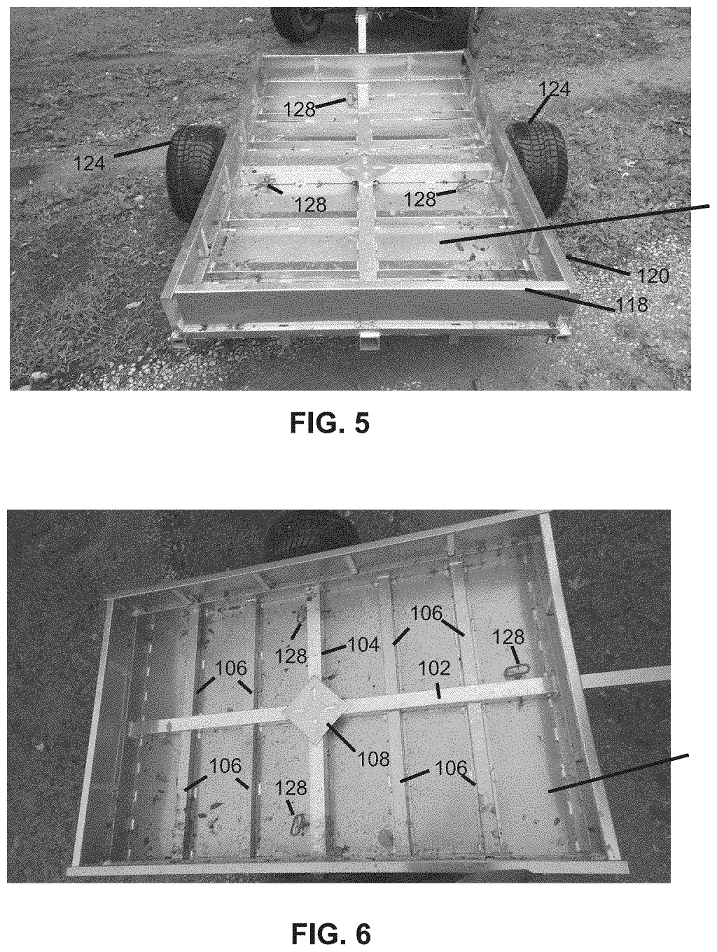

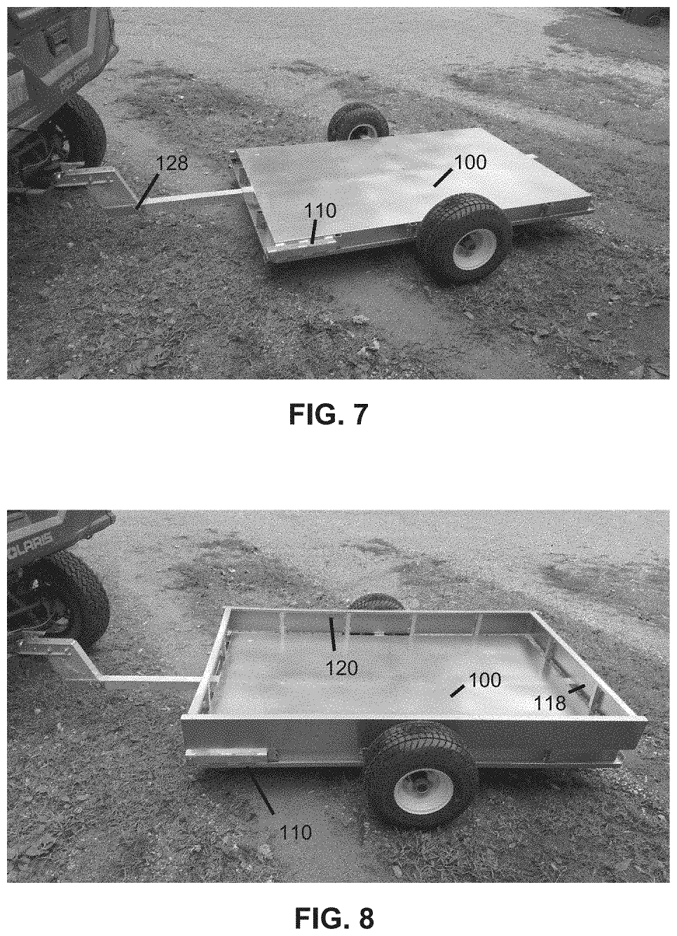

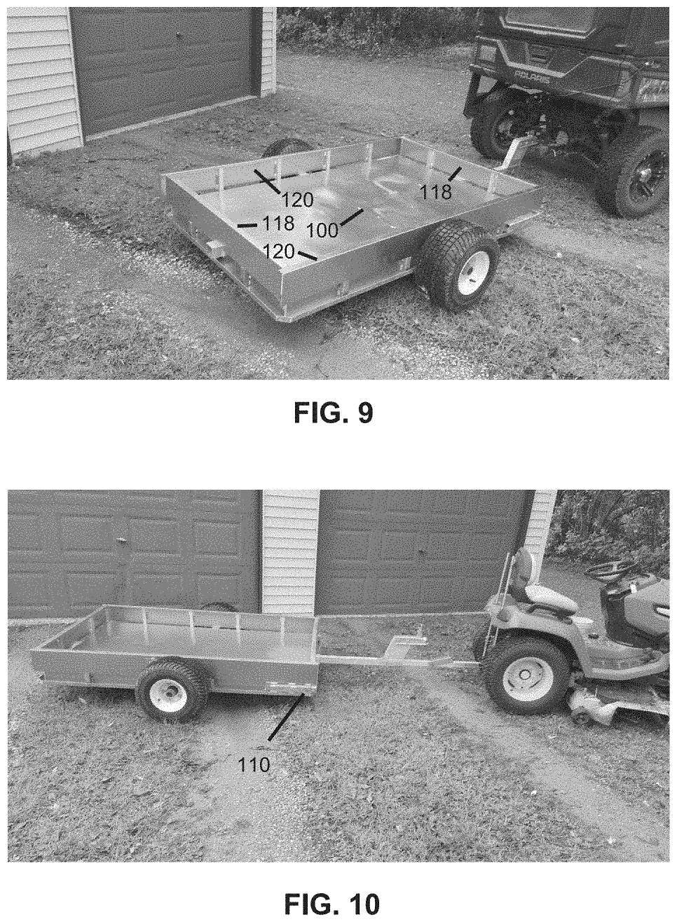

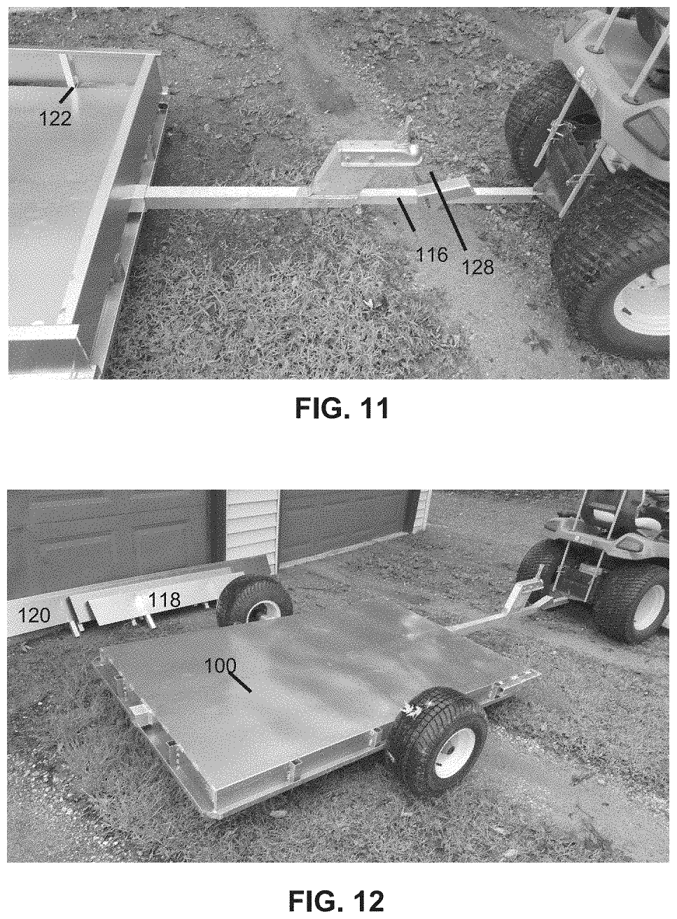

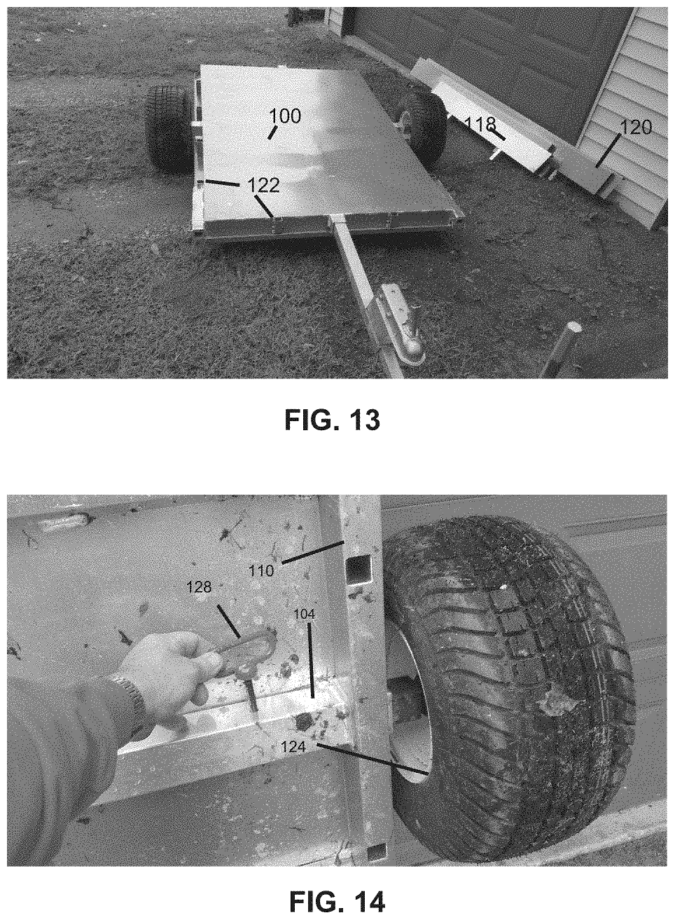

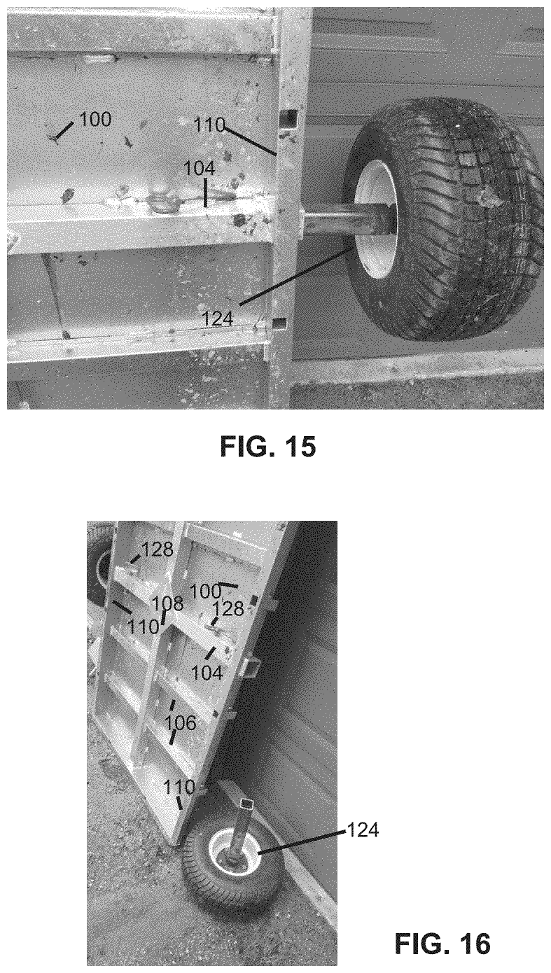

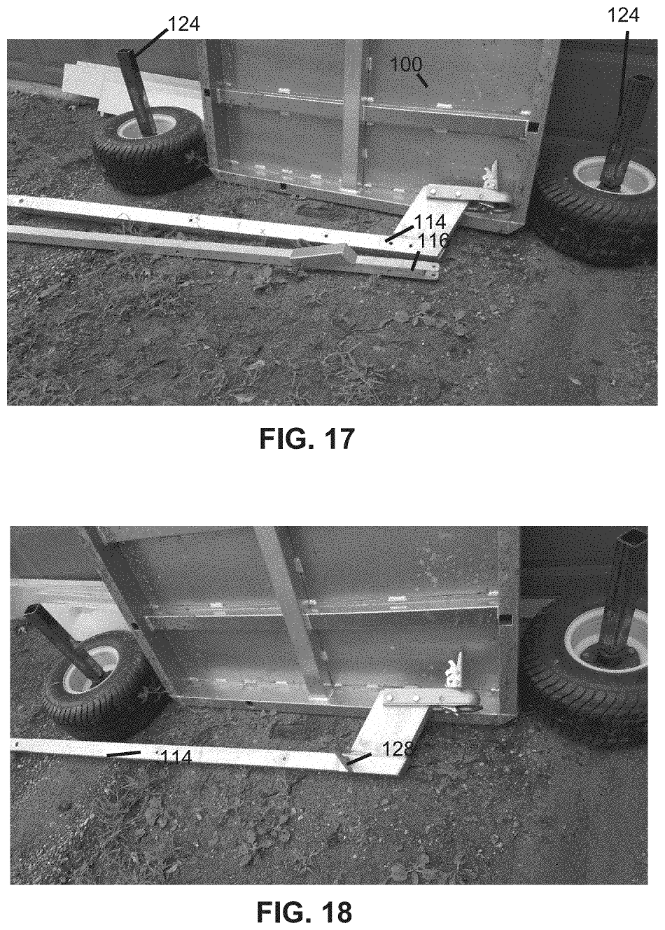

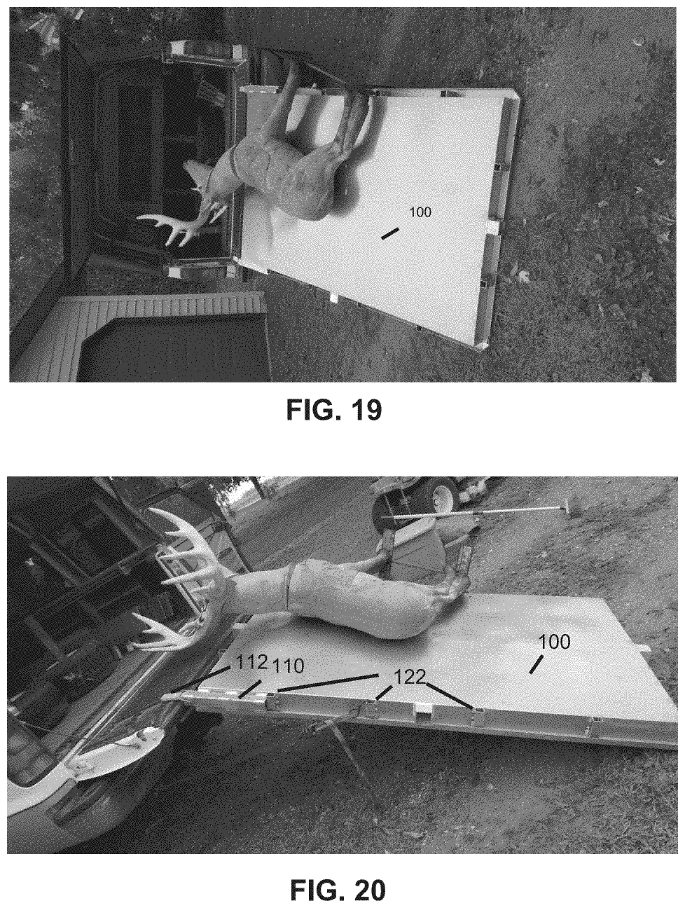

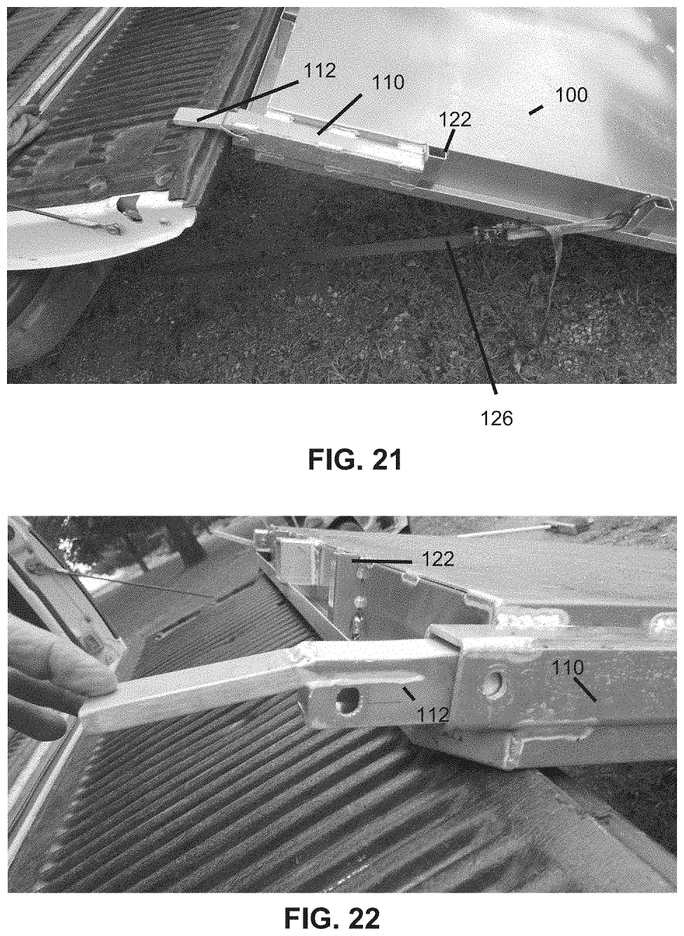

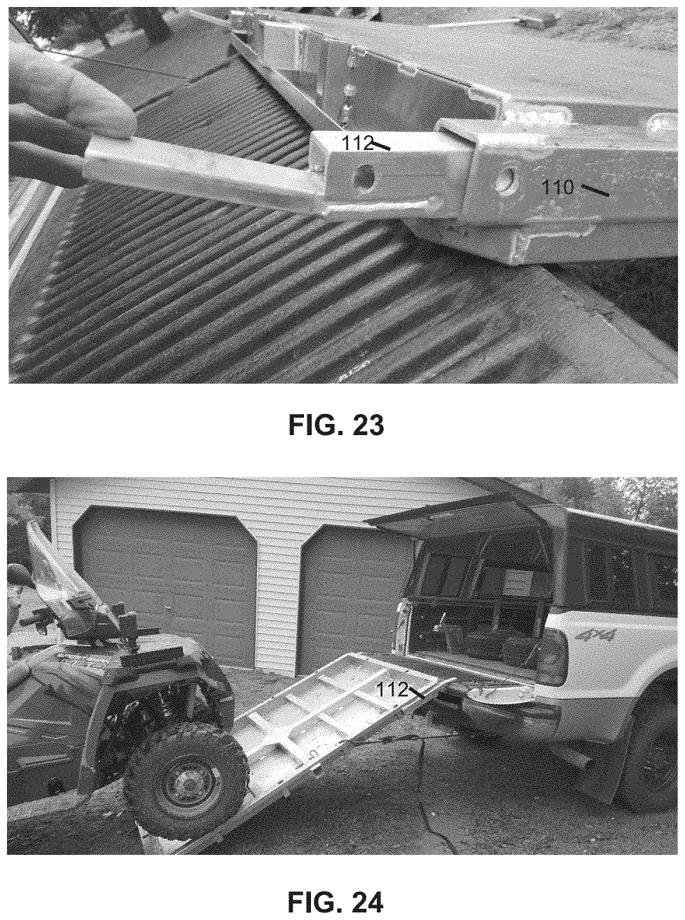

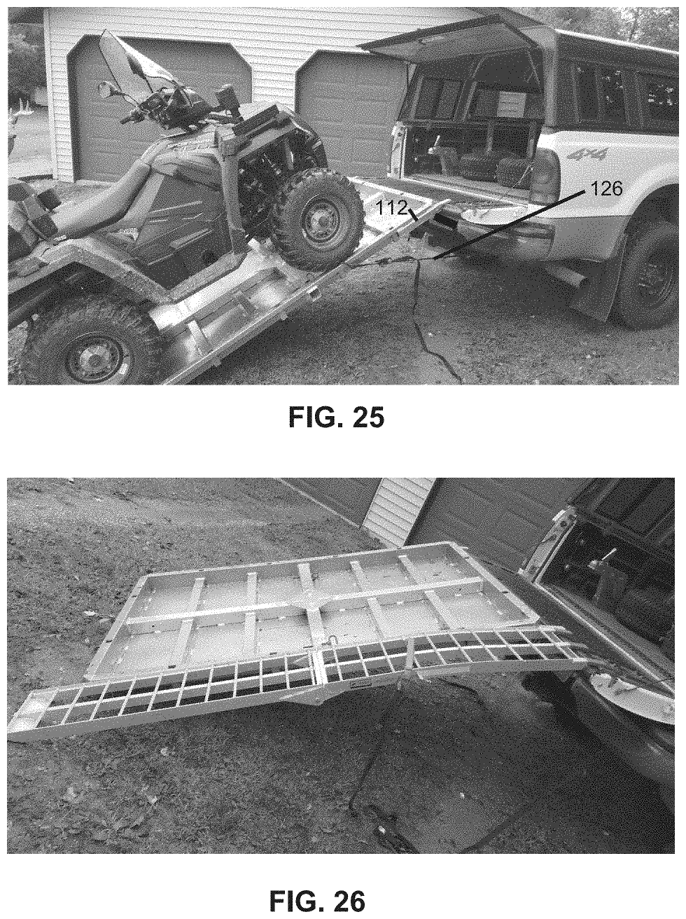

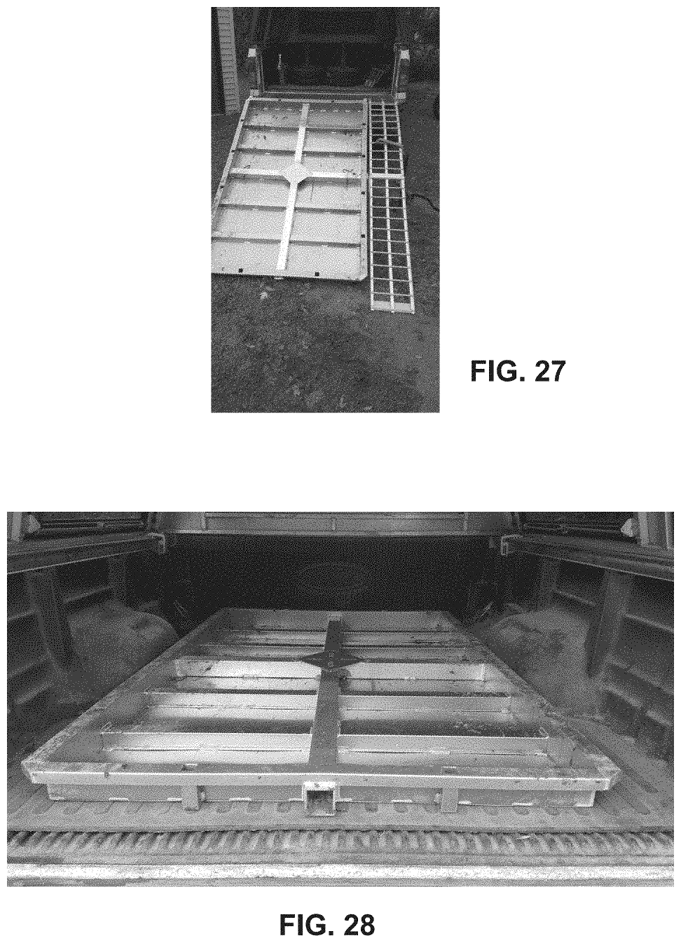

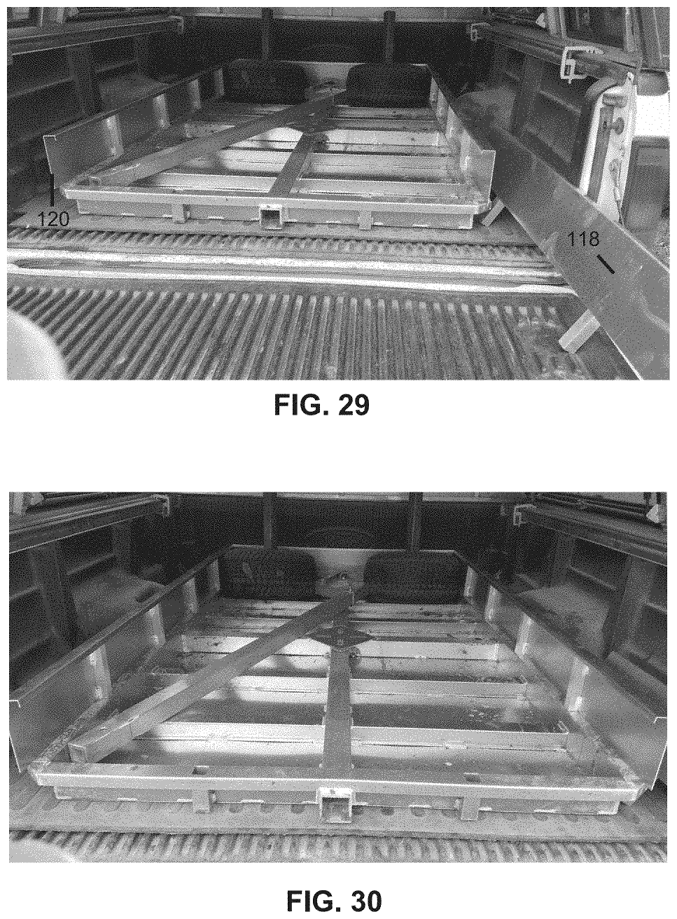

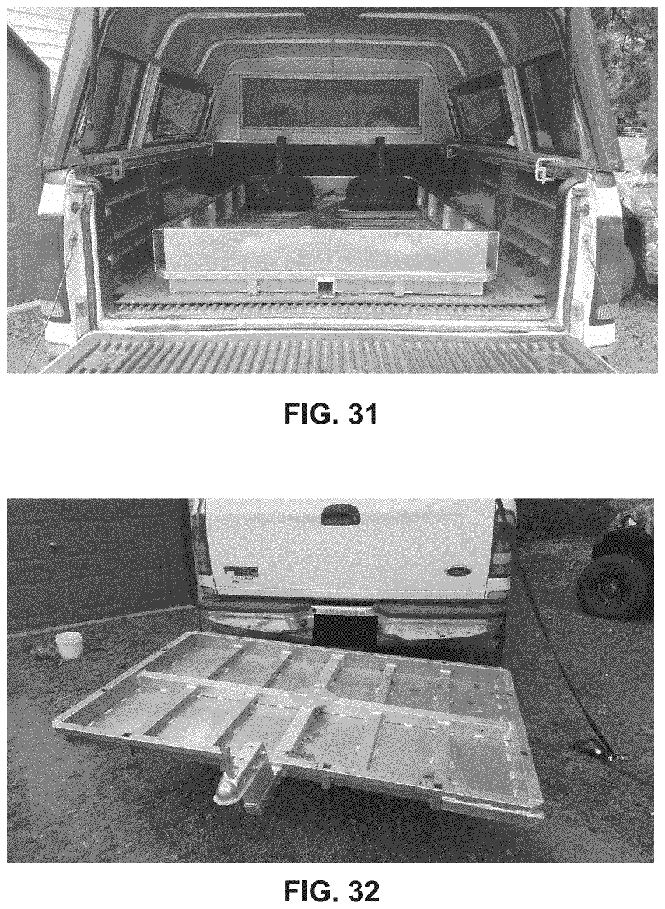

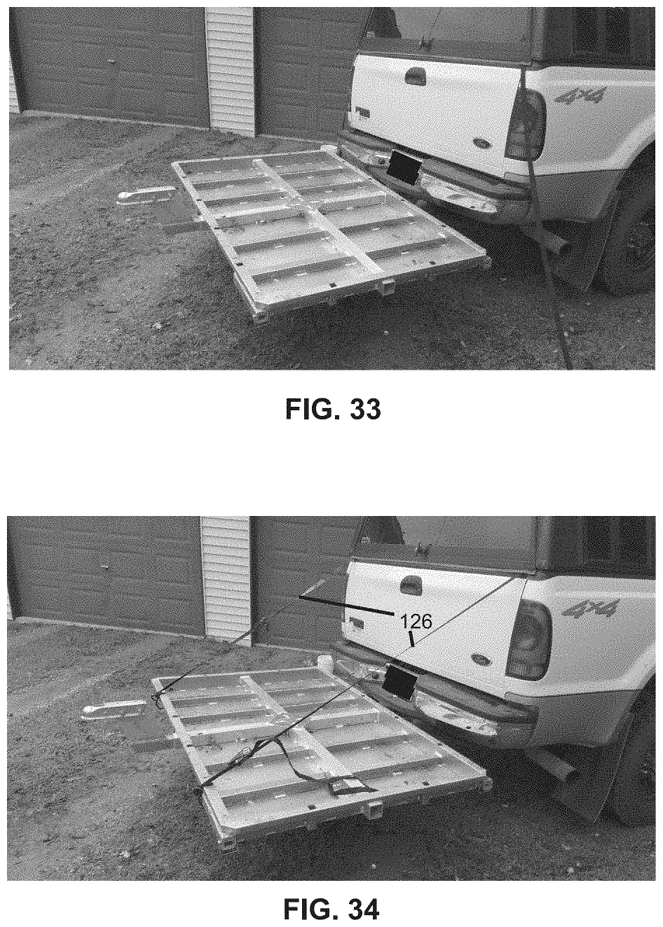

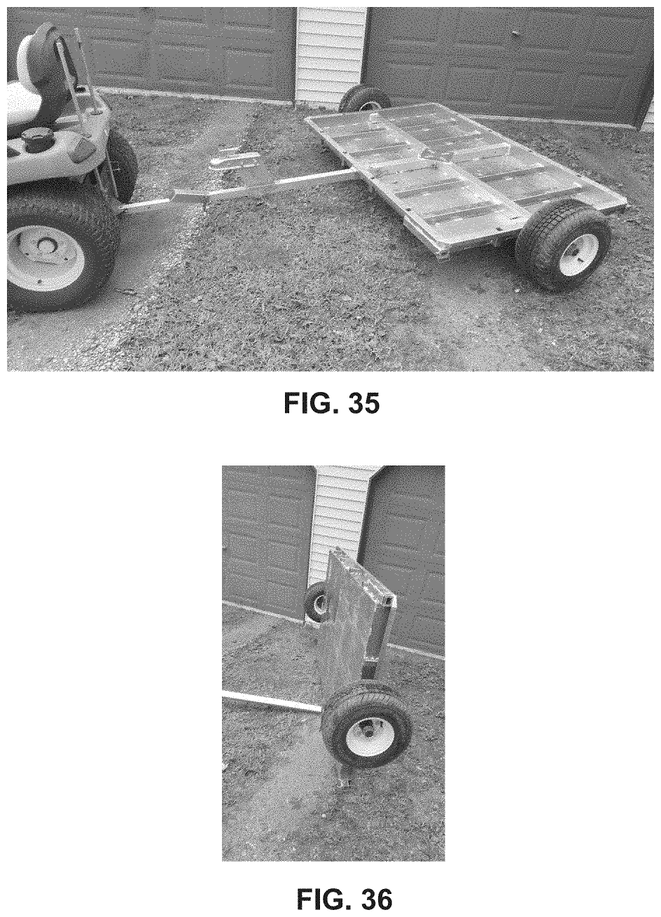

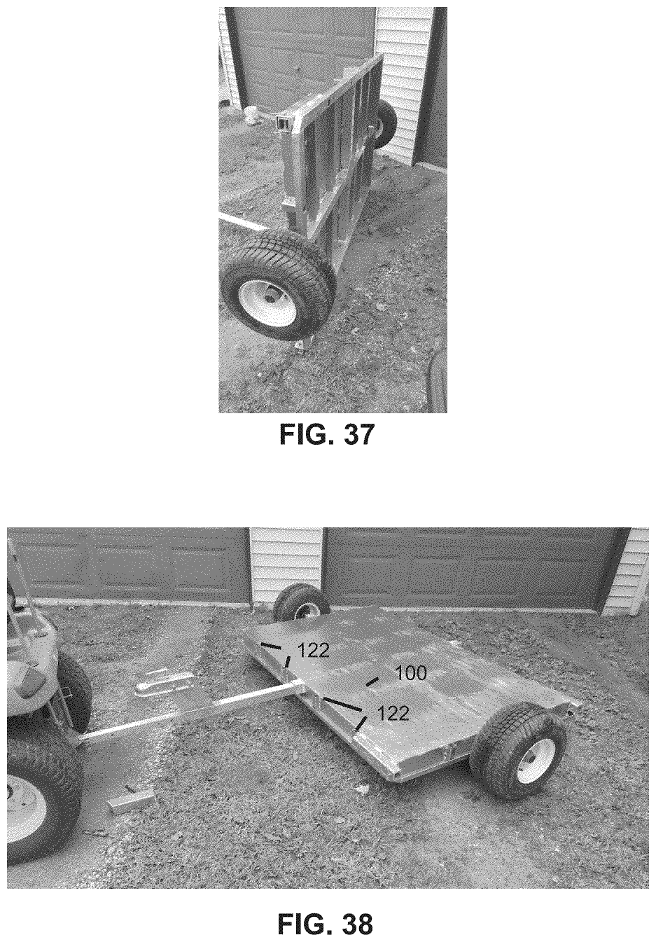

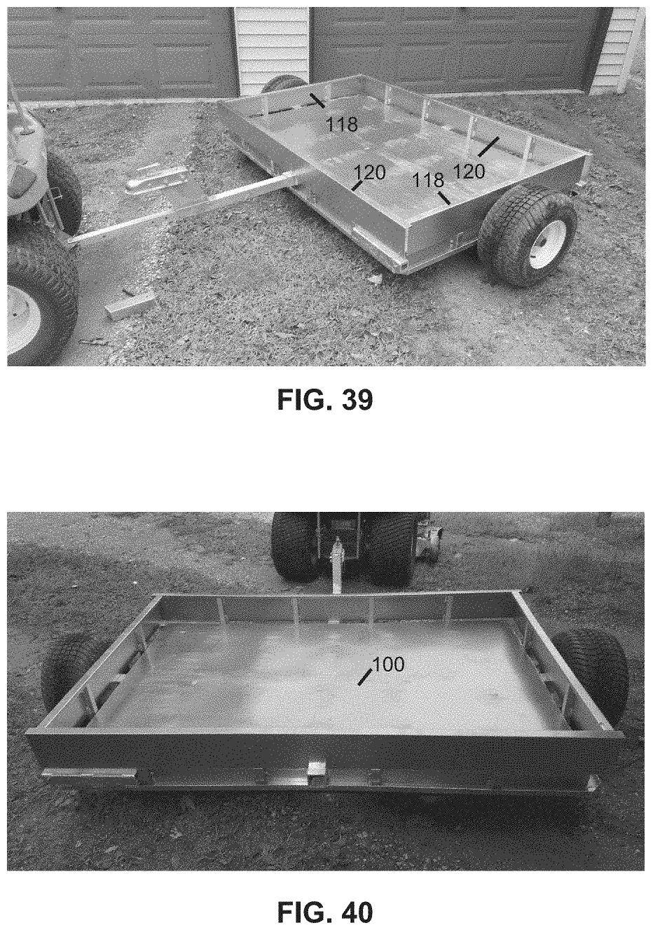

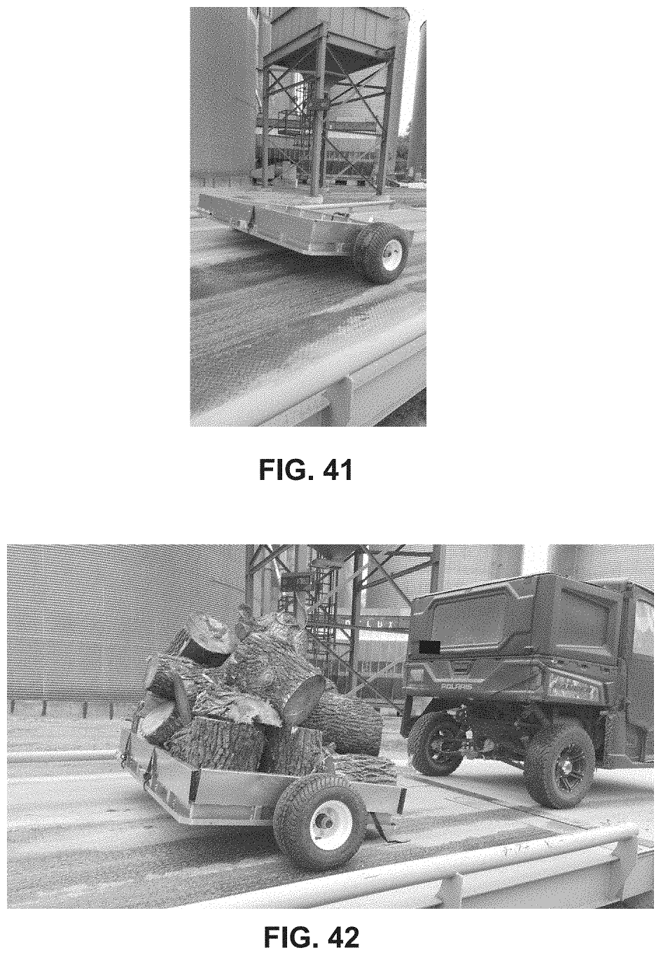

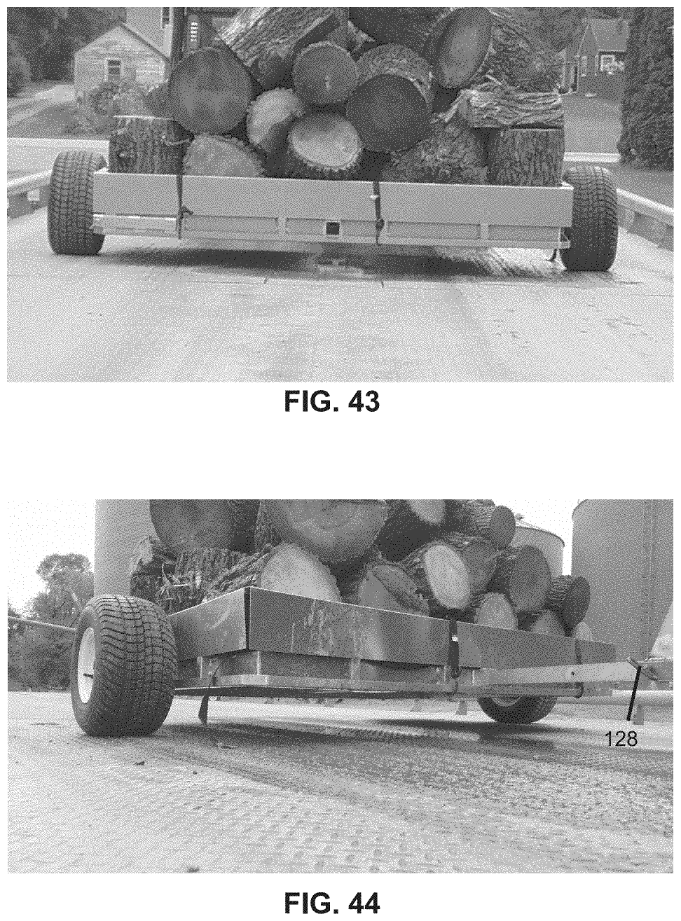

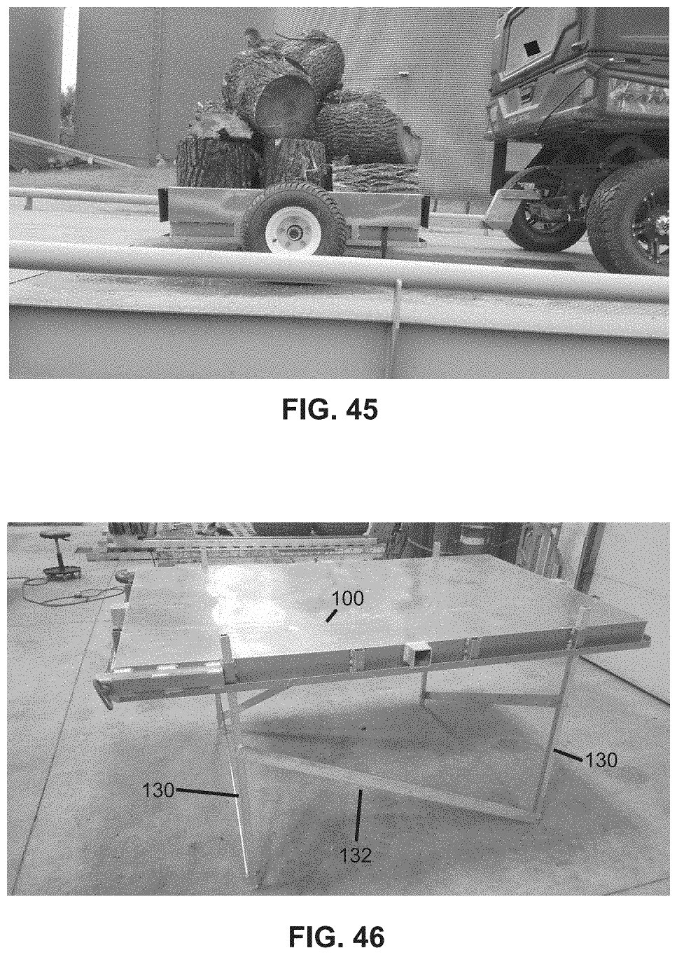

### DETAILED DESCRIPTION

The following detailed description of the present subject matter refers to the accompanying drawings which show, by way of illustration, specific aspects and embodiments in which the present subject matter may be practiced. These embodiments are described in sufficient detail to enable those skilled in the art to practice the present subject matter. Other embodiments may be utilized and structural, logical, and electrical changes may be made without departing from the scope of the present subject matter. References to “an”, “one”, or “various” embodiments in this disclosure are not necessarily to the same embodiment, and such references contemplate more than one embodiment. The following detailed description is, therefore, not to be taken in a limiting sense, and the scope is defined only by the appended claims, along with the full scope of legal equivalents to which such claims are entitled.

Some elements of the trailer are provided below.

| Element | | Quan- | |
|---|---|---|---|
| Number | Part | tity | Dimension |
| 100 | Aluminum Sheet | 1 | 5′ × 8′ × 0.80″ |
| 102 | Long Main Support | 1 | 2.5″ × 2.5″ × ⅛″ × 76″ |
| | Tube | | |
| 104 | Short Main Support | 1 | 2.5″ × 2.5″ × ⅛″ × 50″ |
| | Tube | | |
| 106 | Inner Support Channels | 8 | 2″ × 1¾″ × 3/32″ × 24″ |
| 108 | Middle Square Support | 1 | 8″ × 8″ × ⅛″ |
| | Plate | | |
| 110 | Square Steel Tubes | 2 | 2″ × 2″ × ¼″ × 8″ |
| 112 | Ramp Support Tubes | 2 | 1¼″ × 1¼′″ × 3/32″ × 13″ |
| 114 | Receiver Hitch Tube | 1 | 2″ × 2″ × 6′ × ⅛″ |
| 116 | Inner Hitch Tube | 1 | 1¾″ × 1¾″ × 4′ × 3/32″ |
| 118 | Removable Sides | 2 | 10″ × 50″ × 3/32″ |
| 120 | Removable Sides | 2 | 10″ × 76″ × 3/32″ |
| 122 | Support Tubes | 12 | 1″ × 1″ × 14″ × 3/32″ |
| 124 | Hubs | 2 | 8″ × 5 bolt wheels |
| 126 | Ratchet Straps | 2 | |
| 128 | Pins | 6 | 6″ × ⅜″ |
| 130 | Table Legs | 4 | |
| 132 | Cross Bracing | 4 | |

The dimensions are provided as an example. These dimensions have been found to have some advantages, as they are large enough such that the trailer can be loaded with an all-terrain vehicle or with a large game animal, yet be small enough to be manually lifted and stored in a bed of a passenger pickup truck. Modifications to these dimensions may be made. For example, the sheet may be wider and/or longer if not concerned with fitting in the bed of the pickup truck.

The main supports 102 and 104 of the frame may be welded together. The aluminum sheet may be welded to the main supports 102 and 104 and the inner support channels 106, and the main supports may be welded to each other and to the inner support channels 106. The periphery of the aluminum sheet may be bent around the ends of the inner support channels to form a small wall and a small channel in which the support tubes for the side walls may be welded. The ends of the long and short main support tubes are exposed through the wall such that the wheels 124/hitches 114 and 116 may be inserted into the support tubes. The sidewalls have pegs that are sized and configured to fit within the support tubes along the periphery of the trailer.

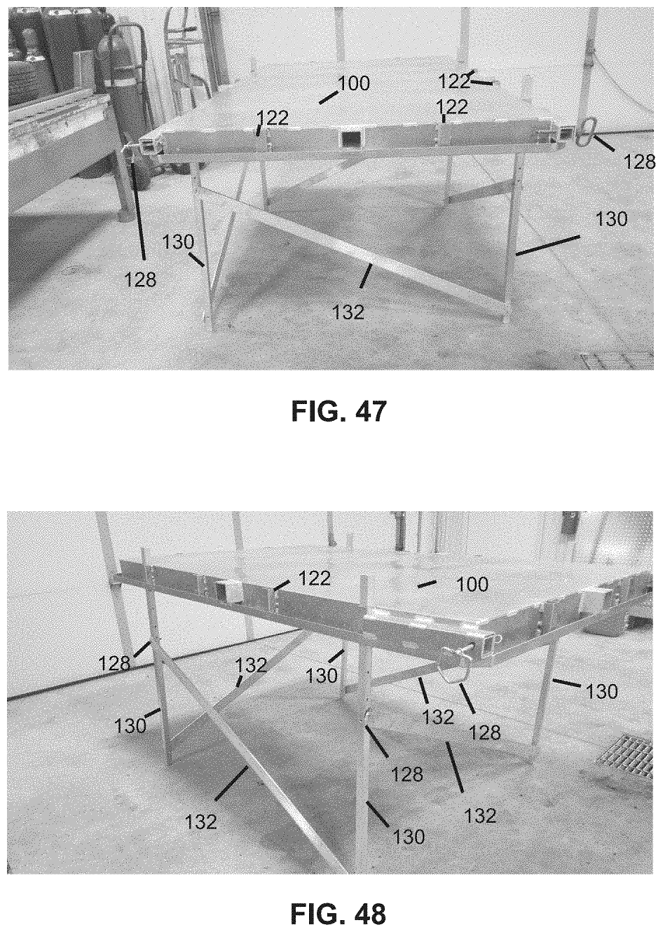

The same support channels that hold the sidewalls may be used with table legs in order form a table (see FIGS. 46-48).

The wheels may be inserted into either of the main supports and the hitch(es) may be inserted into either of the main supports such that the trailer can be configured to be wider and shorter or configured to be thinner and longer.

As the pin holes go the hitch and the hitch and receiver are symmetrical, the hitches may be inserted 180 degrees. This allows the trailer to be configured with the frame side up and the aluminum sheet side down, or with the aluminum sheet side up and the frame side down. By way of example, pulling the trailer with the smooth side down may allow the trailer to glide more easily over rough terrain when used as a game cart with or without wheels.

The frame may have square steel tubes 110 connected to opposing sides of the frame, but openings of the square steel tubes 110 being aligned with an edge of the frame. Ramp support tubes 112 may be inserted and pins may be inserted to secure the ramp support tubes to the square steel tubes 110. The ramp support tubes may have angled braces that may be used to provide a more secure hold on the truck bed.

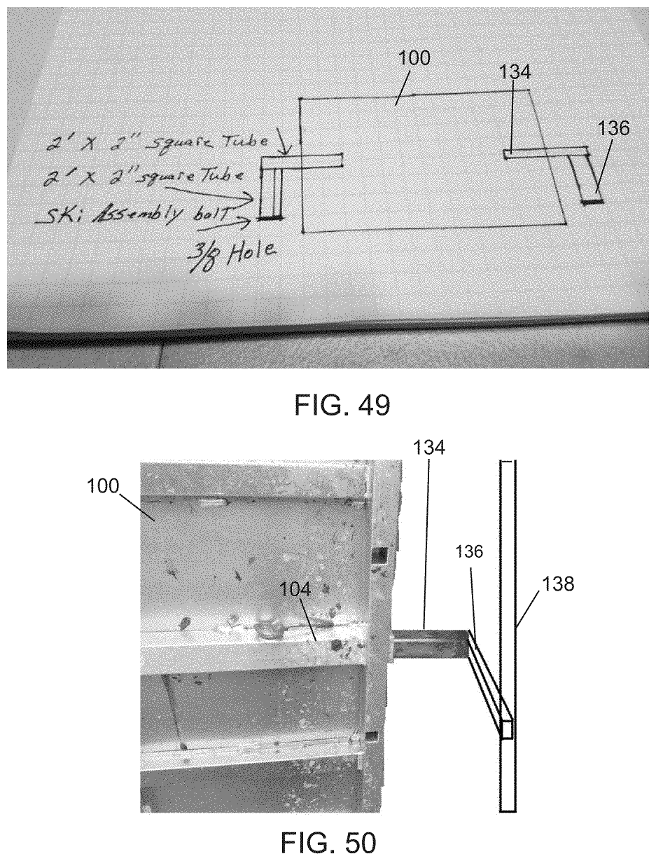

FIGS. 49-50 illustrate a trailer with a ski adapter. The skis may replace the wheels 124. A horizontally-oriented 2 foot long by 2 inch square aluminum tube 134 may slide into the short main support tube 104 where the wheel axle would be inserted. The aluminum tube may have several holes in it to adjust the horizontal distance the skis are away from the body of the trailer (e.g. sheet 100). A vertically-oriented square tube 136 may be slid into the end of the horizontally-oriented square tube. The vertically oriented square tube 136 and the horizontally-oriented square tube 134 can be pinned together. The bottom of the vertically-oriented steel tube has a hole (e.g. ⅜ inch) to mount a ski 138. Thus, ski assembly allows the ski to be adjusted horizontally toward or away from the sheet 100 and the ski to be adjusted vertically toward and away from the sheet 100.

These and other benefits of the trailer are evident in the attached figures.

The above detailed description is intended to be illustrative, and not restrictive. The scope of the disclosure should, therefore, be determined with references to the appended claims, along with the full scope of equivalents to which such claims are entitled.

What is claimed is:

1. A trailer, comprising:
a frame including a first support tube in a longitudinal direction and second support tube in a lateral direction, wherein the first support tube is longer than the second support tube and is perpendicular to the second support tube;
a middle support plate at an intersection of the first and second support tubes, the middle support plate being attached to the first and second support tubes;
a plurality of inner support channels laterally extending from the first support tube, wherein each of the plurality of inner support channels is perpendicular to the first support tube;
an aluminum sheet connected to the frame;
a first wheel and a second wheel, each of the first and second wheels being attached to a hub tube sized and configured to be inserted into ends of the second support tube, wherein the hub tube and the second support tube have aligned apertures through which a pin can be inserted to secure hub tube to the frame;
a plurality of square steel tubes around a periphery of the sheet and oriented perpendicular to the sheet such that each of the plurality of square steel tubes has a top opening;
removable sides, each of the removable sides having pegs configured to fit within at least some of the square steel tubes;
a receiver hitch tube configured to be inserted into an end of the first support tube, the receiver hitch tube configured for use to connect the frame to an on-road vehicle, the receiver hitch tube including an opening; and
an inner hitch tube configured to be inserted through the opening in the receiver hitch tube and secured using a pin inserted through aligned apertures in the receiver hitch tube and the inner hitch tube, the inner hitch tube configured to connect the frame to an off-road vehicle.

2. The trailer of claim 1, comprising:
at least four table legs configured to be inserted into the support tubes, and cross bracing for bracing the table legs such that the aluminum sheet forms a table top.

3. The trailer of claim 1, wherein the frame is configured to be attached to the on-road vehicle without wheels

4. The trailer of claim 1, wherein the frame further includes peripheral tubes with openings on an end of the frame, the trailer further comprising ramp support tubes configured to be inserted into the peripheral tubes and enable the sheet on the frame to form a ramp.

5. The trailer of claim 1, wherein the trailer is configured to be pulled behind an off-road vehicle without wheels and with the aluminum sheet down, thereby forming a game cart for off-road use.

6. The trailer of claim 1, wherein the frame and the attached aluminum sheet are configured for being loaded flat into a pickup truck bed.

7. The trailer of claim 1, wherein the trailer is configurable to be attached to a vehicle oriented with the aluminum sheet on the top and the frame on the bottom, or oriented with the aluminum sheet on the bottom and the frame on the top.

8. A trailer, comprising:
a frame including a first support tube in a longitudinal direction and second support tube in a lateral direction, wherein the first support tube is longer than the second support tube and is perpendicular to the second support tube;
a middle support plate at an intersection of the first and second support tubes, the middle support plate being attached to the first and second support tubes;
a plurality of inner support channels laterally extending from the first support tube, wherein each of the plurality of inner support channels is perpendicular to the first support tube;
an aluminum sheet connected to the frame;
a first ski assembly and a second ski assembly, each of the first and second ski assemblies being configured to be inserted into ends of the second support tube, each of the ski assemblies having a horizontal tube and a vertical tube configured to be received at an end of the horizontal tube, and a ski configured to be attached to a bottom of the vertical tube;
a plurality of square steel tubes around a periphery of the sheet and oriented perpendicular to the sheet such that each of the plurality of square steel tubes has a top opening;
removable sides, each of the removable sides having pegs configured to fit within at least some of the square steel tubes;
a receiver hitch tube configured to be inserted into an end of the first support tube, the receiver hitch tube configured for use to connect the frame to an on-road vehicle, the receiver hitch tube including an opening; and
an inner hitch tube configured to be inserted through the opening in the receiver hitch tube and secured using a pin inserted through aligned apertures in the receiver hitch tube and the inner hitch tube, the inner hitch tube configured to connect the frame to an off-road vehicle.
